(19) United States
(12) Patent Application Publication
(10) Pub. No.: US 2009/0102919 A1
(43) Pub. Date: Apr. 23, 2009

(54) AUDIO-VIDEO SYSTEM AND METHOD FOR TELECOMMUNICATIONS

(76) Inventors: David S. Zamierowski, Overland Park, KS (US); Kathy A. Carver, Overland Park, KS (US)

Correspondence Address: LAW OFFICE OF MARK BROWN, LLC, 4700 BELLEVIEW SUITE 210, KANSAS CITY, MO, 64112, US

(21) Appl. No.: 11/968,043

(22) Filed: Dec. 31, 2007

(51) Int. Cl. H04N 7/18

(52) U.S. Cl. 348/143; 348/E07.085

(57) ABSTRACT

An AV system and method for teleconferencing includes input and output subsystems. The input subsystem includes at least a pair of cameras and a microphone. The cameras can be mounted on a portable cart and adapted for repositioning in order to provide optimum camera spacing and angles to accommodate particular subject matter being covered. The input subsystem is connected to a controller, which can be connected to the Internet or some other network whereby systems at various sites can be linked for teleconferencing multiple participants, who can be either geographically remote from each other or located in close proximity. The output subsystem includes multi-screen displays, which are configured for simulating live participation by viewers. The display devices can be mounted on the cart, along with speakers for playing audio content.

### BACKGROUND OF THE INVENTION

1. Field of the Invention

The present invention relates generally to telecommunications, and in particular to a system and method for teleconferencing with multiple cameras providing input at multiple sites.

2. Description of the Related Art

Audio-video (AV) equipment has been adapted for a wide variety of applications, including recording and transmission of various events in either real-time or delayed transmission broadcast modes. Sports, public meetings and other events are commonly video recorded for real-time or delayed broadcast or rebroadcast. The growing field of safety and security monitoring also provides many applications for AV equipment in a wide variety of roles at various locations.

In the communications field, commercial applications for AV equipment include business and other meetings, for which teleconferencing technology has been used to advantage. Teleconferences commonly involve participants at remote locations. AV teleconferences are intended to provide many of the benefits of live participation including the ability to observe the other participants. Based on the extent of nonverbal communication that normally occurs during conversation via facial expressions, gestures, body language, etc. the ability to observe other meeting participants tends to enhance the experience and the effectiveness of such communications.

AV equipment and technology have also been utilized to advantage in education and training. For example, many fields involve hands-on procedures, which must be observed and studied by students and trainees. In the medical field, diagnostic and treatment procedures involving actual patients are commonly video recorded and/or telecast live. Using such technology, procedures can be monitored in real-time, or recorded for later viewing for educational and training purposes. Real-time observation and monitoring of medical procedures, such as surgery, can enable remote participation and assistance by healthcare professionals located throughout the world.

AV equipment utilizing multiple cameras and networking has previously been utilized, but not with the advantages and features of the present invention.

### SUMMARY OF THE INVENTION

In the practice of an aspect of the present invention, an AV telecommunications system and method are provided with multiple input devices, such as cameras and microphones. Multiple output devices can also be utilized, such as split-screen displays equipped with speakers at various remote sites in order to simulate live meetings, even though the actual participants are located at two or more remote sites. The equipment is designed for portability in order to maximize its usefulness.

### BRIEF DESCRIPTION OF THE DRAWINGS

FIG. 1 is a block diagram of a telecommunications system embodying an aspect of the present invention.

FIG. 2 is a perspective view of a mobile cart equipped with adjustable-position cameras and a split-screen display.

FIG. 3 is a perspective view of another mobile cart equipped with adjustable-position cameras and a split-screen display.

FIG. 4 is a perspective view of yet another mobile cart equipped with adjustable-position cameras and a split-screen display.

FIG. 5 is a perspective view of a videoconference covered by two cameras and a microphone.

FIG. 5A is a front elevational view of a split-screen display of the conference shown in FIG. 5 with the cameras in fixed-geometry operating modes.

FIG. 5B is a front elevational view of a split-screen display of the conference shown in FIG. 5 and another conference.

FIG. 5C is a front elevational view of another split-screen display of the conference shown in FIG. 5 and three other conferences.

FIG. 5D is a front elevational view of an alternative split-screen display of the conference shown in FIG. 5 with the cameras in variable-geometry operating modes.

FIG. 6 is a perspective view of another videoconference with four cameras and two microphones covering the participants.

FIG. 6A is a front elevational view of a split-screen display of the conference shown in FIG. 6.

FIG. 7 is a perspective view of the AV telecommunications system, shown covering a medical procedure.

FIG. 7A is a front elevational view of a split-screen display of the medical procedure shown in FIG. 7.

FIG. 8 is a perspective view of an alternative AV telecommunications system embodying another aspect of the present invention, shown covering a medical procedure.

FIG. 8A is a front elevational view of a split-screen display of a medical procedure, captured with the AV telecommunications system shown in FIG. 8.

FIG. 9 is a perspective view of a split-screen display of another medical procedure, including a close-up of a patient area of interest and a healthcare professional's hand located thereat.

### DETAILED DESCRIPTION OF THE PREFERRED EMBODIMENTS

### I. Introduction and Environment

As required, detailed embodiments of the present invention are disclosed herein: however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. “Head(s)”. “foot” and “feet” generally refer to the respective ends of a table, such as a conference table or a table for performing medical procedures, or a hospital bed. Said terminology will include the words specifically mentioned, derivatives thereof and words of similar meaning.

Referring to the drawings in more detail, the reference numeral 2 generally designates an AV telecommunications system embodying an aspect of the present invention. Without limitation on the generality of useful applications of the system 2, an exemplary application is for AV teleconferencing.

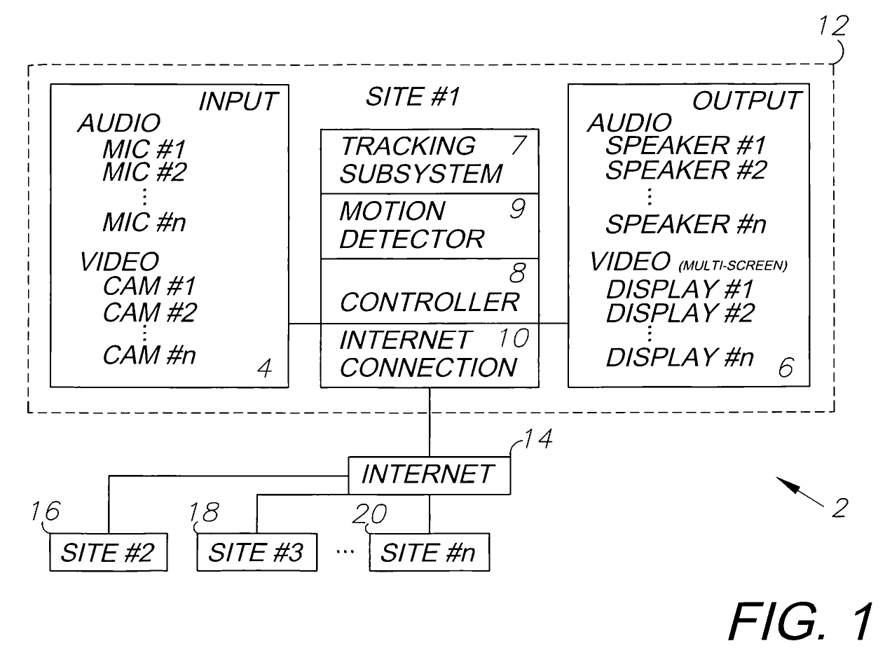

As shown in FIG. 1, the system 2 generally comprises an input subsystem 4, an output subsystem 6, a controller 8 (e.g., a computer capable of handling the various functions associated with AV teleconferencing and including sufficient memory) and an Internet (worldwide web) connection 10. The system 2 can include various subsystems and components connected to the controller 8 for providing functionalities associated with teleconferencing, such as a tracking subsystem 7, which can be preprogrammed for directing the cameras and other input devices towards particular targets, such as objects and individuals and specific activities of interest. A motion detector 9 can also be provided for such functionalities as system 2 activation upon a person entering a camera field defined by a conference room or a hospital room (actual or simulated), or in response to audio input.

All of the system components can be suitably interconnected for transmitting, receiving, processing and storing data in the form of electronic signals. i.e. in binary format, and can be located at a suitable site installation 12 (e.g. Site No. 1). Via the Internet 14, additional site installations Nos. 2, 3 . . . n (designated 16, 18, 20) can be connected online with the system 2.

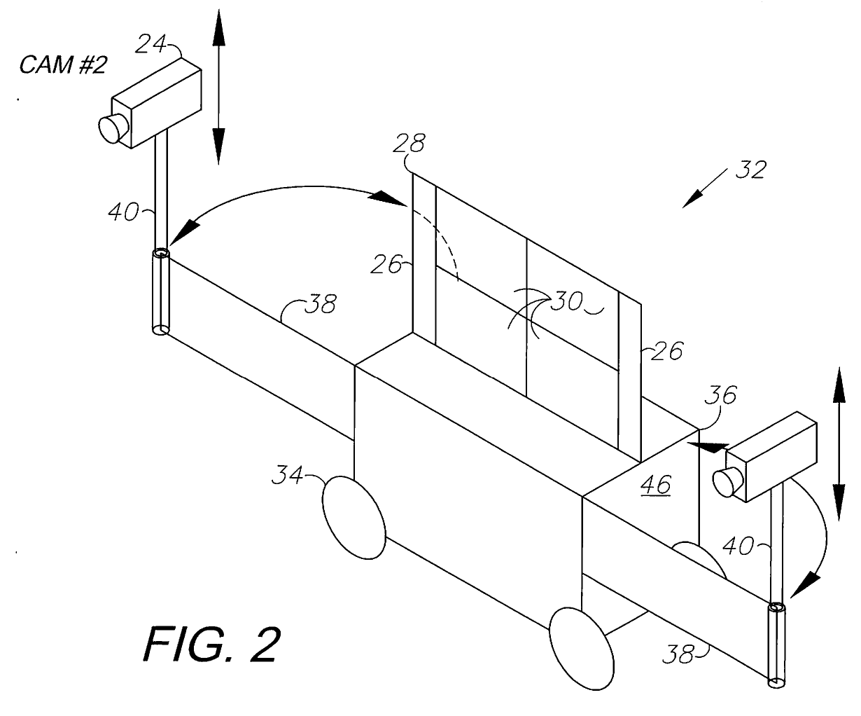

The input subsystem 4 includes audio input comprising multiple microphones 22 and video input comprising multiple cameras 24. The output subsystem 6 can include multiple speakers 26 and a split-screen (multi-screen) video display device 28 comprising multiple individual displays 30. A portable unit comprising a cart 32 can incorporate some or all of the components of the site installation 12 (FIG. 2). The cart 32 includes wheels 34 for portability and a cabinet 36, which can house and mount the components of the site installation 12. Folding arms 38 are pivotally mounted on the cabinet 36, and each mounts a camera support column 40, which can be vertically moved between raised and lowered positions for positioning the cameras 24 at the appropriate heights. The display screen 28 can be lowered into the cart cabinet 36 and raised therefrom to a viewing position as shown in FIG. 2. The tracking subsystem 7 can optionally be utilized for controlling microphone 22 and camera 24 positions and orientations via the controller 8 and automatic-positioning functionalities of the cart 32.

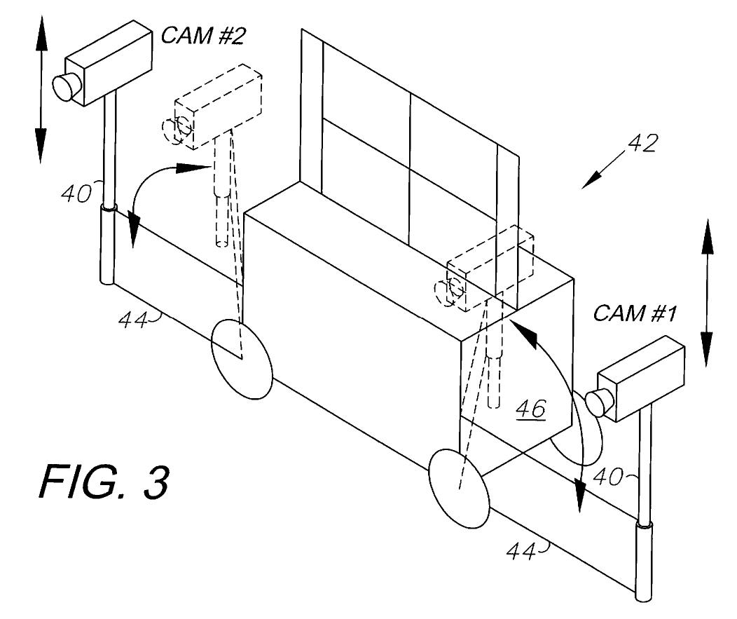

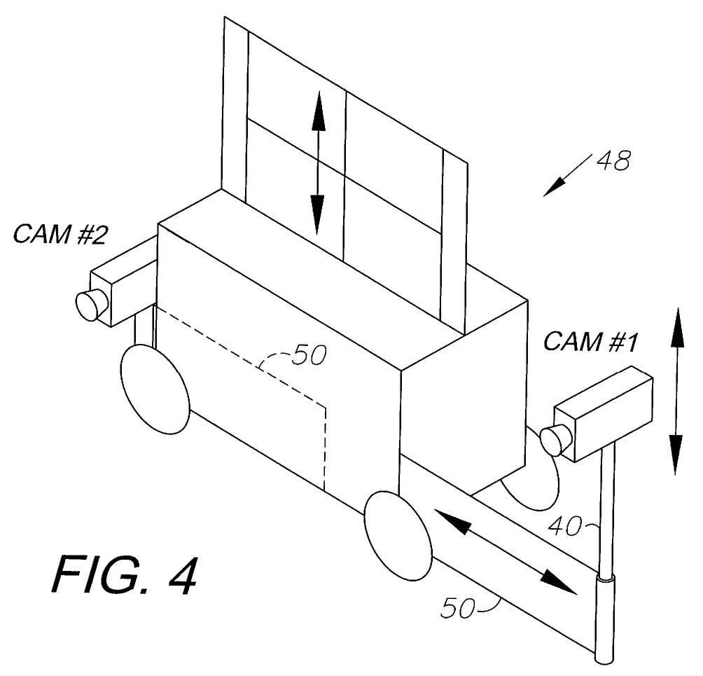

FIG. 3 shows an alternative construction cart 42 with arms 44 pivotally mounted for swinging upwardly into proximity with the cart side faces 46. FIG. 4 shows yet another alternative construction cart 48 with arms 50 for telescopically, laterally extending and retracting through the cart side faces 46. The cart 42 is designed for reconfiguring between use positions with the cameras 24 spaced apart and elevated, and transport/storage configurations sufficiently compact to pass through doorways and occupy minimal storage space.

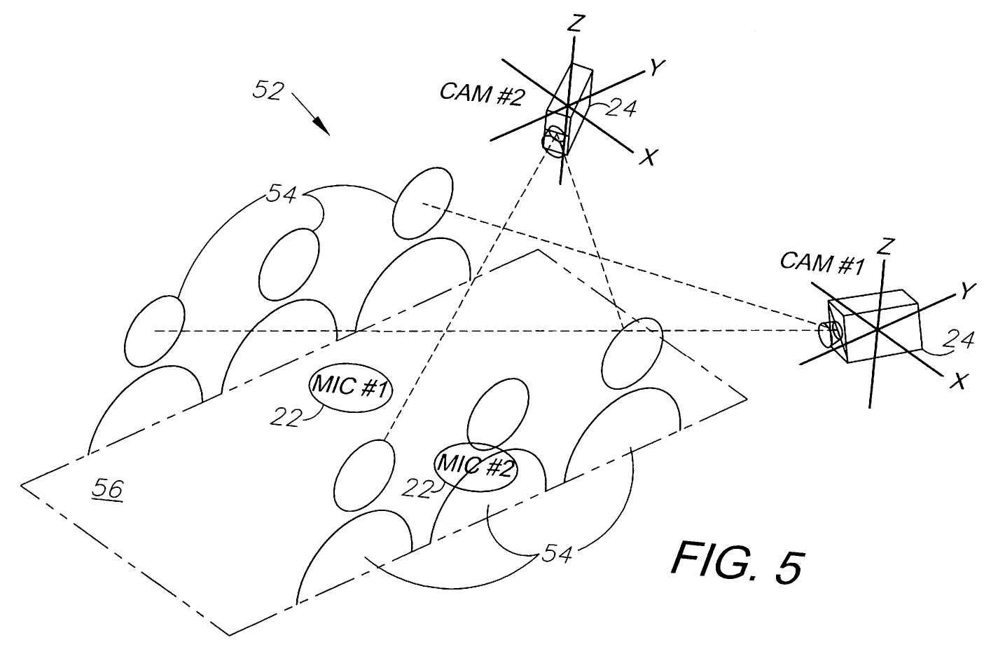

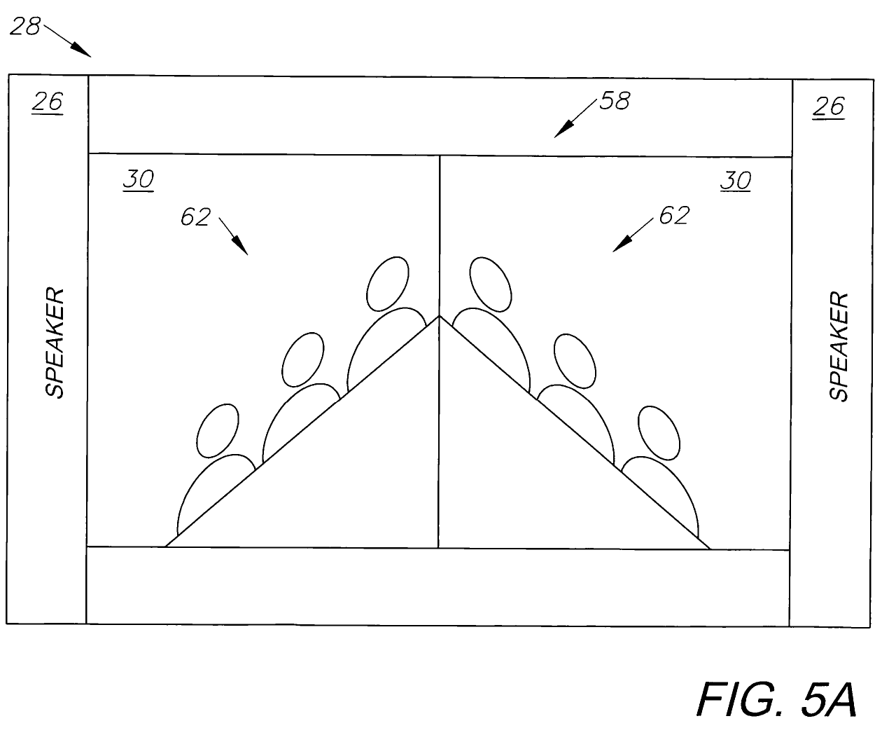

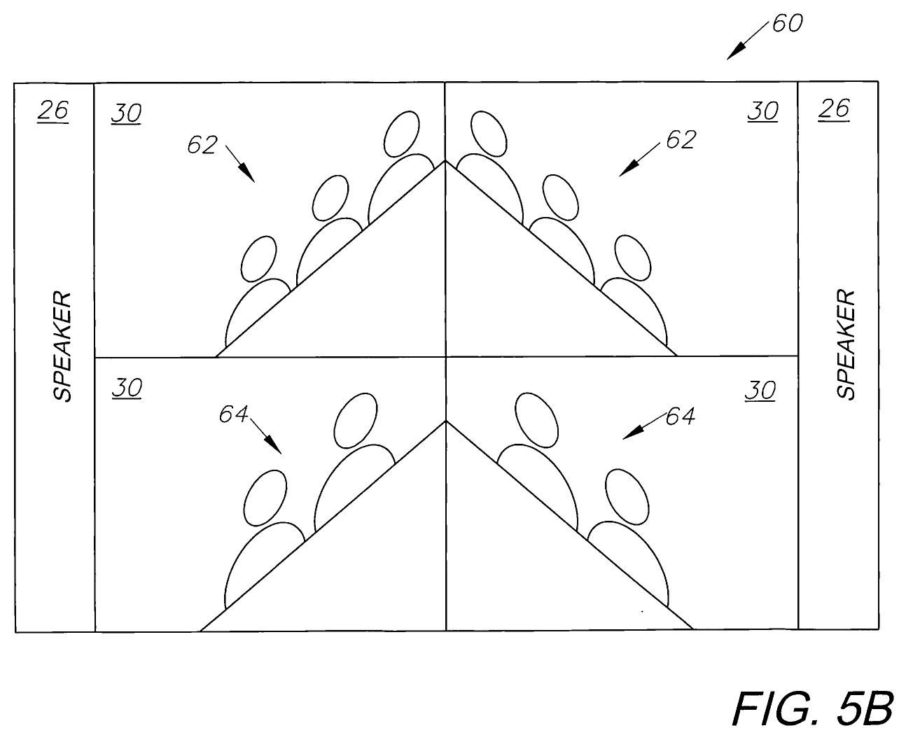

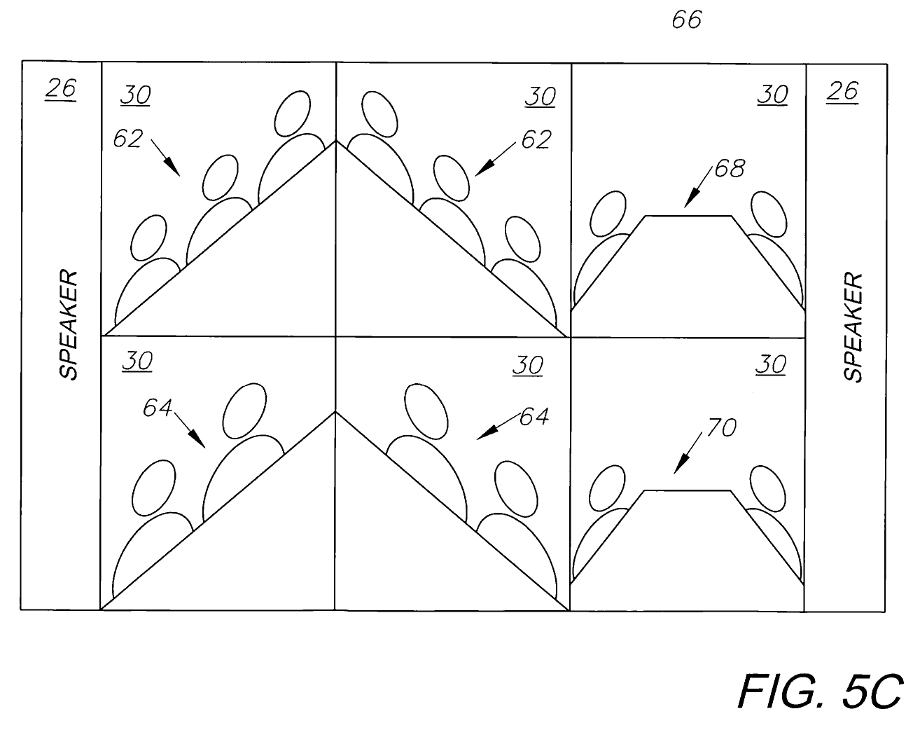

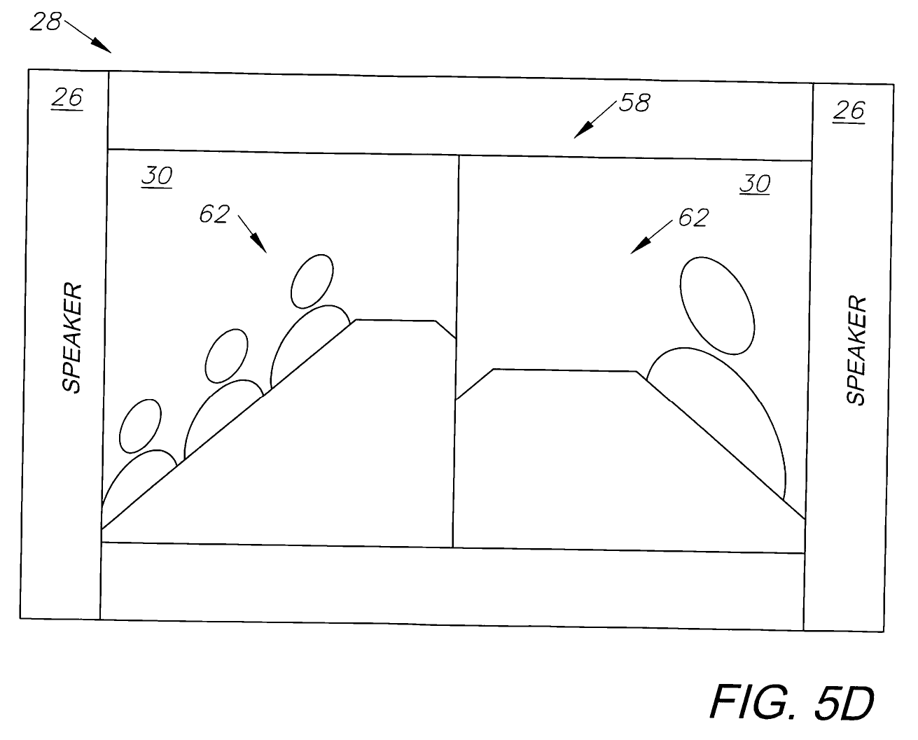

FIG. 5 shows an exemplary application of the AV teleconferencing system 2 in a teleconference setting 52 including participants 54 on each side of a conference table 56. A pair of cameras 24 is each directed at the participants 54 located on a respective side of the table 56. A pair of microphones 22 is placed on the table 56 in proximity to the participants on each side. FIG. 5A shows a split-screen display output 58 of the teleconference 52, including displays 30 each corresponding to the view from a respective camera 24. The cameras 24 are thus cross-angled with crossing fields of vision, which are adjustable for variables including camera height, view angle, direction, etc. Such variables can be preset and fixed, or dynamically operator-adjustable through controls, which can also enable such functions as panning and zooming. The view of FIG. 5A can be obtained with the cameras 24 in a fixed-geometry operating mode whereby their heights, angles, directions and other operating variables can be preset, for example to accommodate a particular table or meeting group size. The speakers 26 are cross-matched to the output from the microphones 22 located in front of the participants being recorded by the respective cameras 24. The effect of the output 58 is a close approximation to attending the teleconference 52 live whereby the participants are observed on their respective sides of the table 56 and are heard in “stereo” effect, with their voices seemingly emanating from their respective table sides. The display shown in FIG. 5A uses the viewers' natural ability to mentally combine closely-matched but “seamed” (i.e., related but different) images to enable monitoring a more unitary presentation, which is perceived as single-screen even though the screen 28 is actually split into displays 30. The camera 24 operating parameters can be preset or adjusted as needed in order to facilitate such mental combining function. Greater situational comprehension can thus be achieved because simultaneous metal comprehension is limited to relatively few images or other stimuli. The optimum camera 24 operating parameters can be predetermined and preprogrammed as the default operating configuration for the system 2.

FIG. 5B shows another multi-screen display 60 with participants 54 from separate six-person and four-person conferences 62, 64 respectively depicted in upper and lower parts of the display, with each conference 62, 64 being covered by a pair of cameras 24 as described above. FIG. 5C shows yet another display 66 with a six-screen display showing a six-person conference 62, a four-person conference 64 and two-person conferences 68, 70. It will be appreciated that the variety of combinations of conference locations and participants is virtually unlimited. For example, the individual conferences can be occurring simultaneously in real-time in geographically remote locations, or in the same facility or even in the same room. Event displays can be delayed and otherwise time-shifted for display later, e.g. to coincide with participation by other participant groups. FIG. 5D shows a display of the conference in FIG. 5 with the cameras 24 in variable-geometry operating modes. The left side 30 of the display 58 shows multiple participants 54 on a side of the conference table 56, whereas the right side 30 of the display 58 shows a close-up of an individual participant 54 utilizing pan and zoom functionalities of the system 2.

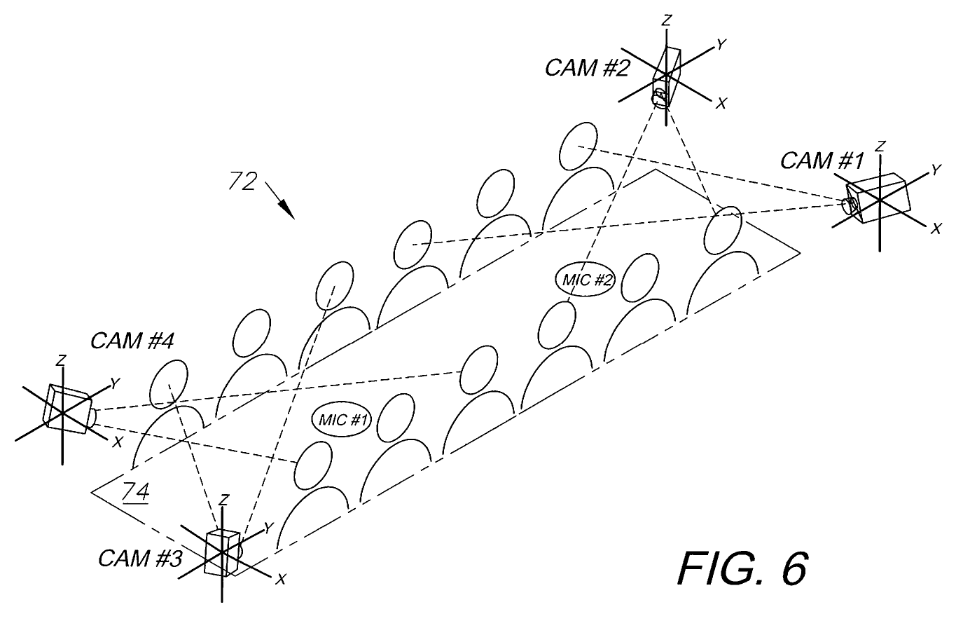

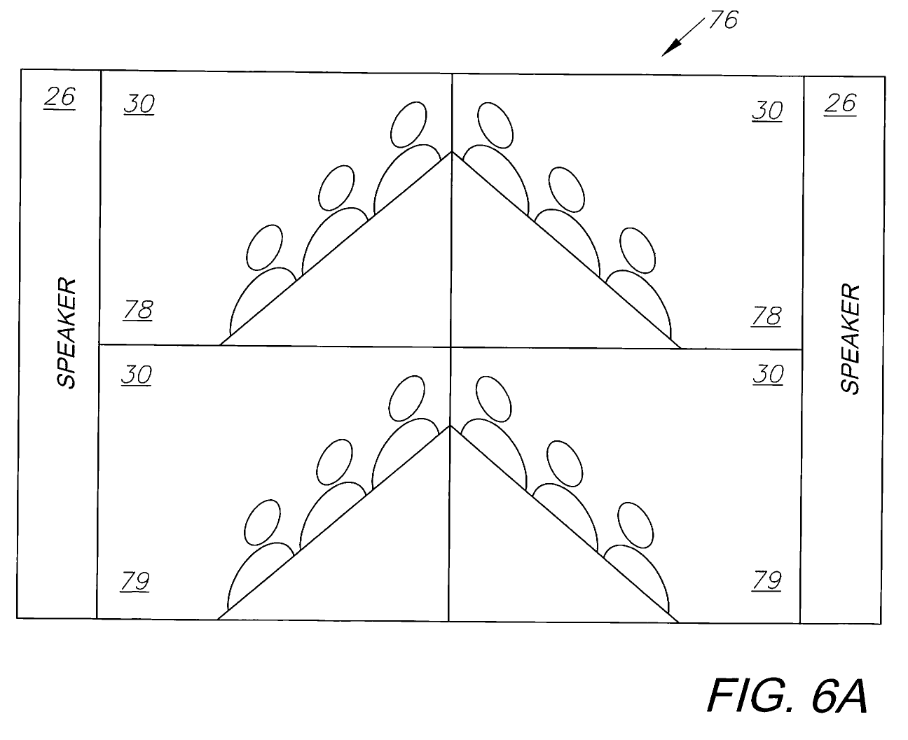

FIG. 6 shows an application of the AV teleconferencing system 2 for covering a relatively large (twelve participants 54) teleconference 72 at a single conference table 74. A pair of cameras 24 is located at each end (i.e. the head and foot) of the table 74 for receiving and displaying images. Microphones 22 are placed at both ends of the table 74 and provide audio input corresponding to the video input from the cameras 24. The resulting four-display screen output 76 is shown in FIG. 6A wherein each group of six participants is separately depicted on a pair of upper and lower displays 78, 79 providing a similar output display to that shown in FIG. 5A, but doubled in order to accommodate the larger group conference 72.

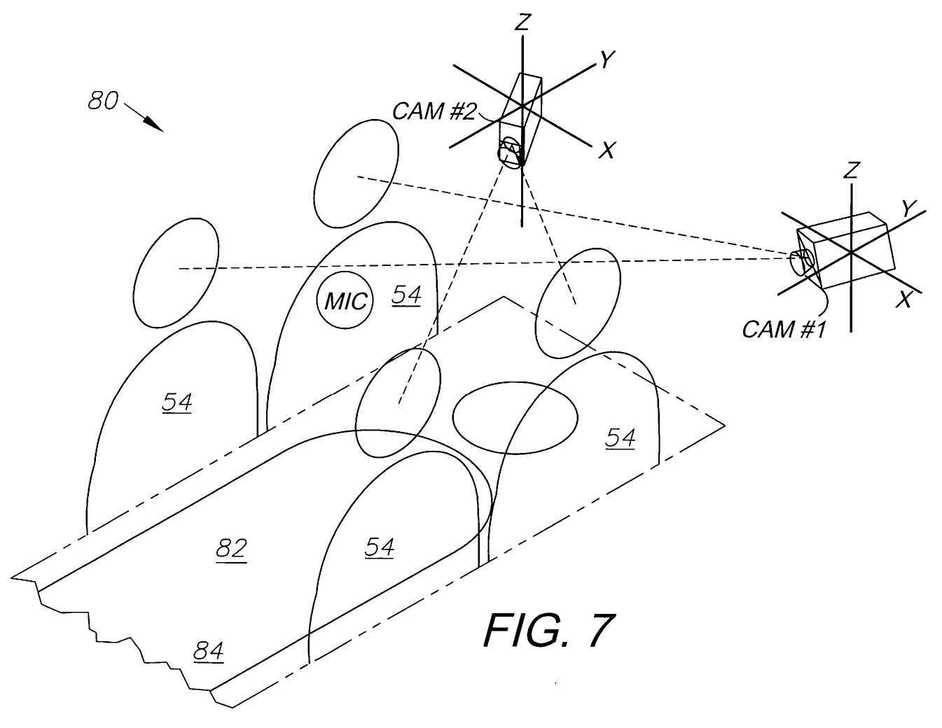

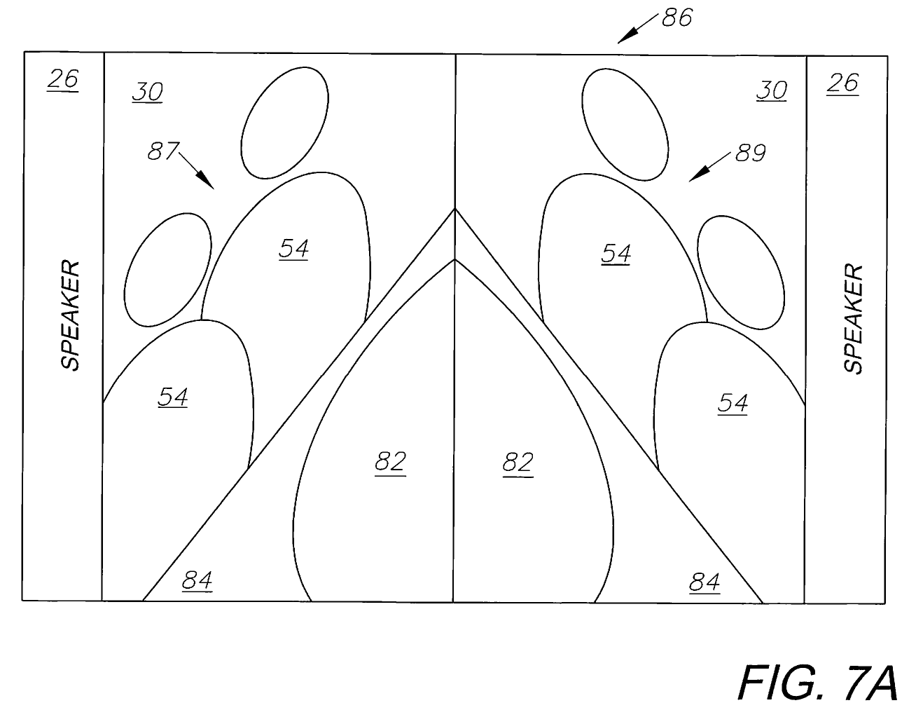

FIG. 7 shows an application of the system 2 in connection with a medical procedure 80, involving a patient 82 lying on a hospital bed or treatment table 84 and adjacent participants 54, who can comprise healthcare professionals providing or observing treatment. Another important application of the system 2 is in the medical education/training field. Instructors and students can participate in and observe various medical procedures. Moreover, the objects of such procedures can be actual live patients or simulators. The field of medical simulation has achieved a level of sophistication enabling effective training with simulators or mannequins exhibiting human analog functions and characteristics, such as vital signs, various “symptoms” and physical findings. Such simulators can be preprogrammed with medical situation scenarios for training and educational sessions. Our copending U.S. patent application Ser. No. 11/751,407 for Healthcare Training System and Method, which discloses such simulation technology and applications, is incorporated herein by reference.

The input subsystem 4 can comprise a pair of cameras 24 suitably placed in proximity to and above the bed or treatment/operating table 84 head. A microphone 22 can be suspended above the bed or table 84. A split-screen display device 86 is shown in FIG. 7A and shows the participants 54 from two angles, as described above in connection with a teleconference meeting application. A pair of juxtaposed displays 87, 89 enables focusing on particular areas of interest, either participants 54, patient 82 or both (e.g., utilizing the split-screen functionality). The camera views can be directed to coincide on a participant or a particular area of interest. Realigning and repositioning the cameras 24 (either manually or via the controller 8) allows an operator to independently shift the area of interest located in the views of both cameras 24. However, the pre-placement of the cross-angled cameras 24 and the associated reverse alignment of the split screen display 28 in easily-assimilated panoramic fashion can provide nearly frontal views of bedside or tableside participants without having to change the camera position and thus allows utilization of this system without the need of a dedicated camera operator.

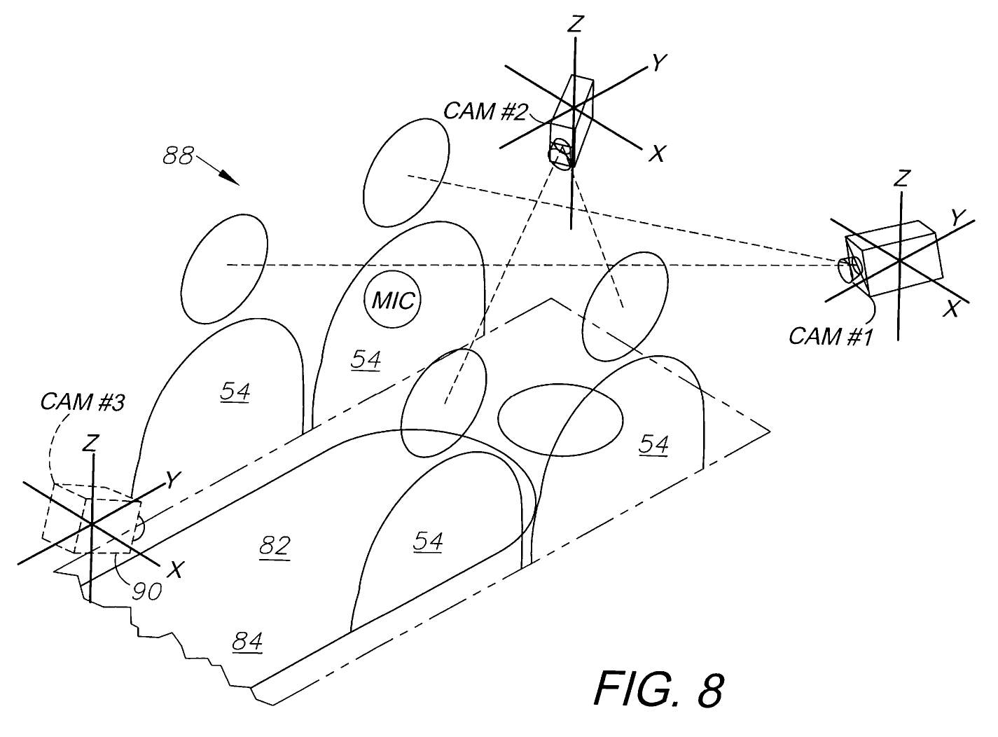

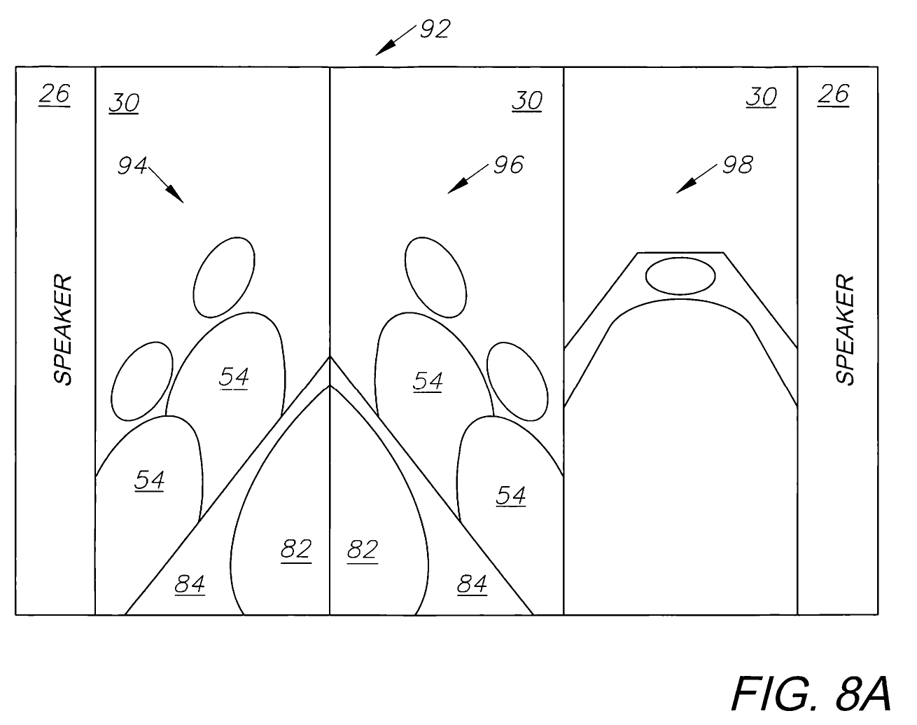

FIG. 8 shows a medical procedure 88 covered by a pair of cameras 24 located at the head of the bed or treatment table 84, and a third camera 90, which can be located generally above the patient 82 or even beyond the foot of the bed or treatment table 84. An output display 92 of the monitoring system shown in FIG. 8 is shown in FIG. 8A and includes a pair of screens 94, 96 depicting the participant 54 views from the head cameras 24 and a third screen 98 depicting the patient 82 view from the third camera 24.

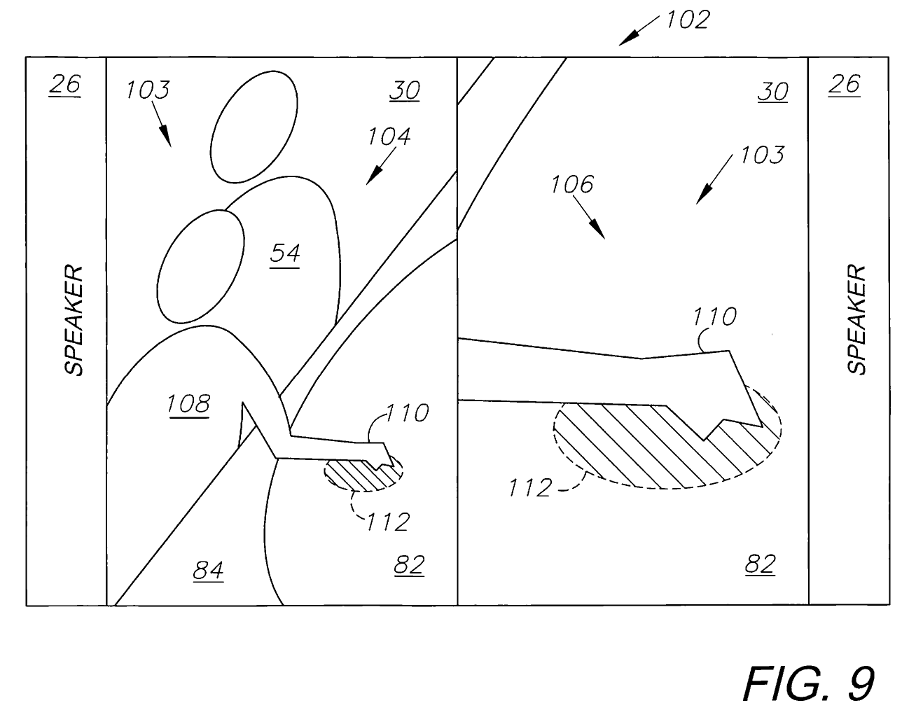

FIG. 9 shows an output display 102 displaying a medical or other procedure 103 on first and second split-screens 104, 106, with a treating healthcare professional 108 engaging a patient 82 area of interest 112 with his or her hand 110. One or both of the cameras 24 can automatically track and zoom in on the hand 110 and the area of interest 112 via the tracking subsystem 7, or in response to manually-input display commands. For instance, an instructor located outside of a simulated hospital or operating room can closely monitor actions by a student/trainee using such camera angle and zoom functionalities. Advantageously, multiple training sessions can be monitored using this methodology, thus leveraging the effectiveness of instructional staff and facilities resources.

It will be appreciated that input device configurations, such as camera angles and positions, are virtually unlimited. However, it has been observed that positioning a pair of cameras 24 approximately 2-3 feet laterally from the edge of a table or bed, 6-12 inches behind a line flush with the head of the table or bed and at approximately eye-level (approximately 4 feet for a seated person and approximately 6 feet for a standing person) provides good coverage of conference participants seated at a conference table, or of a patient in bed or on a medical treatment table with limited camera angles and lines of site. A preconfigured portable device is thus feasible and should require only limited ranges of extension and adjustability in order to provide useful and desirable views for display.

The functionalities of the system 2 are also virtually unlimited. For example, the cameras 24 can be provided with pan and zoom features. The controller 8 can be operated by a remote-control device. Various hard-wired and wireless (RF) connecting systems can be utilized for the various components.

It is to be understood that the invention can be embodied in various forms, and is not to be limited to the examples discussed above. Other components and configurations can be utilized in the practice of the present invention.

What is claimed and desired to be secured by Letters Patent is as follows:

1. An audio-visual (AV) method for displaying an event with participants occurring at an event location to an audience at a remote location, which method comprises the steps of:
orienting a first camera with a first configuration at said event location towards the event;
orienting a second camera with a second configuration at said event location towards the event;
outputting AV content from said cameras;
processing the output from said first and second cameras with a central controller;
transmitting the AV content from said central controller to said remote location; and
displaying said transmitted AV content on a single display screen.

2. The method according to claim 1, which includes the additional step of:
reorienting said cameras with said controller.

3. The method according to claim 2, which includes the additional steps of:
dividing said display screen into multiple displays.

4. The method according to claim 1, which includes the additional steps of:
storing a preprogrammed default orientation for said cameras in said controller;
orienting said cameras towards said event according to said default orientation;
panning said event with said cameras operating independently via said controller; and
zooming said cameras independently on said event via said controller.

5. The method according to claim 1, which includes the additional steps of:
providing a portable cart with said cameras mounted thereon;
providing said cart with a cabinet;
providing said cart with a screen movable between a lowered position retracted into said cart cabinet and a raised position extending upwardly from said cabinet; and
displaying on said screen multiple screen displays of an event occurring at a remote location from multiple angles.

6. The method according to claim 5, which includes the additional steps of:
providing said cart with a pair of camera arms;
pivotably mounting said arms on opposite sides of said cart;
each said arm being pivotable between an extended position extending laterally outwardly from a respective cabinet side and a retracted position folded alongside a respective cabinet side; and
adjustably mounting each said camera on a respective arm.

7. The method according to claim 6 which includes the additional step of, vertically adjusting said cameras between raised and lowered positions.

8. The method according to claim 5, which includes the additional steps of:
providing said cart with a pair of arms telescopically extendable from and retractable into said cabinet between extended and retracted positions;
mounting a respective camera on each said arm; and
vertically adjusting each said camera between raised and lowered positions on a respective arm.

9. The method according to claim 1, which includes the additional step of teleconferencing a meeting comprising said event.

10. The method according to claim 9, which includes the additional step of reorienting a camera towards an item associated with said meeting independently of said other camera orientation.

11. The method according to claim 5 which includes the additional step of teleconferencing a medical procedure comprising said event.

12. The method according to claim 11, which includes the additional step of reorienting a camera towards a patient region of interest associated with said medical procedure independently of said other camera orientation.

13. The method according to claim 12, which includes the additional steps of:
remotely assisting with said medical procedure;
recording said medical procedure; and
evaluating said medical procedure.

14. The method according to claim 5, which includes the additional step of:
splitting said screen display with said controller into multiple, individual screen displays; and
enhancing a viewer's seamless impression of said multiple images comprising said screen display from multiple said cameras by manipulating the content of the output on said screen.

15. The method according to claim 5, which includes the additional steps of:
providing said carts at multiple locations;
remotely controlling the camera orientations at a first location from a second location; and
remotely controlling the camera orientations at said second location from said first location.

16. The method according to claim 5, which includes the additional steps of:
dividing said screen with said controller into multiple images; and
subdividing at least one of said divided images into multiple, subdivided images independently of said other divided images.

17. A method for teleconferencing events at first and second event locations remote from each other, which comprises the steps of:
orienting a first camera with a first configuration at each said event location towards the event at said location;
orienting a second camera with a second configuration at each said event location towards the event at said location;
outputting AV content from said cameras;
processing the output from said cameras with a central controller;
transmitting the AV content from said central controller to said locations;
displaying said transmitted AV content on a display device at each location;
reorienting said cameras with said controller;
dividing said display into multiple views;
storing a preprogrammed default orientation for said cameras in said controller;
orienting said cameras towards said events according to said default orientation;
panning said events with said cameras operating independently via said controller;
zooming said cameras independently on said events via said controller;
providing a portable cart with said cameras mounted thereon at one of said locations;
providing said cart with a cabinet;
providing said cart with a screen movable between a lowered position retracted into said cart cabinet and a raised position extending upwardly from said cabinet;
displaying on said screen multiple screen displays of an event occurring at a remote location from multiple angles;
providing said cart with a pair of camera arms;
mounting said arms on opposite sides of said cart;
each said arm being movable between an extended position extending laterally outwardly from a respective cabinet side and a retracted position folded alongside a respective cabinet side;
adjustably mounting each said camera on a respective arm;
vertically adjusting said cameras between raised and lowered positions;
vertically adjusting each said camera between raised and lowered positions on a respective said arm;
at one of said locations reorienting a camera towards at least one of an item or a person associated with a respective event independently of said other camera orientation;
splitting said screen display with said controller into multiple, individual screen displays;
enhancing a viewer's seamless impression of said multiple images comprising said screen display from multiple said cameras by manipulating the video output content displayed on said screen;
remotely controlling the camera orientations at said first location from said second location;
remotely controlling the camera orientations at said second location from said first location;
dividing said screen with said controller into multiple images;
subdividing at least one of said divided images into multiple, subdivided images independently of said other divided images;
providing multiple microphones and speakers at each said location;
providing audio input to said controller from said microphones;
providing audio output from said controller to said speakers;
providing a visual tracking system;
connecting said tracking system to said controller;
programming said controller to track video content associated with a person, object or event;
tracking said video content with said tracking system;
directing a camera to said tracked video content;
providing a motion detector at one of said locations;
connecting said motion detector to said controller;
detecting motion at said one location with said motion detector;
activating said system in response to motion detection;
teleconferencing said events;
recording said events; and
evaluating said events.

18. An AV system for teleconferencing events at first and second locations, which includes:
first and second cameras at each of said first and second locations;
first and second microphones at each of said first and second locations;
a controller connected to and receiving input from said first and second cameras and microphones;
said controller including a camera orientation function for remotely and independently orienting said cameras at said locations;
said controller including a predetermined, default orientation for said cameras;
a display device at each location;
a speaker at each location;
said controller displaying and playing said transmitted AV content on said display device and said speaker at each location;
said controller including a function for reorienting said cameras remotely;
said controller including a function for displaying multiple views on said display device;
said controller including a function for panning at each location with said cameras operating independently of each other; and
said controller including a function for zooming said cameras independently of each other.

19. The system according to claim 18, which includes:
a portable cart with said cameras mounted thereon at least one location;
said cart including a cabinet;
said cart including a screen movable between a lowered position retracted into said cabinet and a raised position extending upwardly from said cabinet;
said cart including a pair of camera arms, each camera arm including a proximal end mounted on a respective side of said cart and a distal end;
said camera arms being adapted for moving between extended positions extending laterally outwardly from said cabinet sides and retracted positions relative to said camera sides; and
each said camera arm including a vertically adjustable camera support column located at its distal end and mounting a respective camera.

20. The system according to claim 18 which includes:
a visual tracking system connected to said controller;
said controller being programmed to track video content associated with a person, object or event and direct said camera to said tracked video content;
a motion detector located at one of said locations and connected to said controller; and
said controller being programmed to activate said system in response to motion detection.
